(19) United States
(12) Patent Application Publication
(10) Pub. No.: US 2006/0174637 A1
(43) Pub. Date: Aug. 10, 2006

(54) Electronic timing device

(75) Inventor: Francis Ford Coppola, Rutherford, CA (US)

Correspondence Address: Alison J. Baldwin;McDonnell Boehnen Hulbert & Berghoff, 32nd Floor, 300 S. Wacker Drive, Chicago, IL, 60606, US

(73) Assignee: The Coppola Companies, San Francisco, CA (US)

(21) Appl. No.: 11/052,273

(22) Filed: Feb. 7, 2005

(51) Int. Cl. B67B 7/00; G01F 11/00; F25B 49/00; G05D 23/32; F25B 19/00

(52) U.S. Cl. 62/125; 62/157; 62/231

(57) ABSTRACT

This invention discloses an electronic timing device for measuring a single interval of time. The electronic timing device comprising an activating mechanism, a timing element that measures a single interval of time upon activation by the activating mechanism, and a visual indicator that is activated by the timing element upon the elapse of the single interval of time.

### FIELD OF THE INVENTION

This invention relates to the field of timing devices and, more particularly, relates to timing devices that measure a single interval of time.

### BACKGROUND

Many people prefer to consume beverages after they have been chilled to a temperature below room temperature. Because most non-perishable beverages are commonly sold at room temperature, the consumer must chill the beverage prior to drinking. Unfortunately, it can require an extended length of time to properly chill the room temperature beverage in a standard refrigerator prior to drinking.

In order to decrease the time required for chilling the beverage, the consumer may place the room temperature beverage in a standard freezer. Two problems can arise with this attempt to rapidly chill the beverage. One problem is that the beverage may partially or completely freeze if left in the freezer for too long a period of time. Not only is the beverage usually undrinkable in this frozen state, but some beverage containers can rupture due to the increased volume of the frozen beverage inside the container. A second problem often occurs in an effort to avoid freezing the beverage. In this scenario, the person who placed the beverage in the freezer may check on the beverage repeatedly while it is being chilled in the freezer. Not only does this repeated inspection of the beverage prevent the person from engaging in other activities during the chilling of the beverage, but it also slows the chilling process by increasing the temperature of the freezer due to the repeated exposure of the freezer compartment to the room temperature air.

Thus, I have observed that there is a need for a device that is portable and simple to use and which conveniently alerts a person when a beverage has been chilled sufficiently and should be removed from the freezer.

### SUMMARY OF THE INVENTION

The present invention provides an electronic timing device comprising an activating mechanism, a timing element that measures a single interval of time upon activation by the timing mechanism; and a visual indicator that is activated by the timing element upon the elapse of the single interval of time.

The present invention further provides a method for rapidly chilling a room temperature beverage comprising the steps of placing a beverage container into a freezer, activating an electronic timing device comprising an activating mechanism, a timing element that measures a single integral of time upon activation by the activating mechanism, and a visual indicator that is activated by the timing element upon the elapse of the single integral of time, activating a visual indicator upon expiration of the single interval of time, and removing the container of beverage from the freezer upon activation of the visual indicator.

### BRIEF DESCRIPTION OF THE FIGURES

FIG. 1 is a simplified illustration of one exemplary embodiment of the external features of an electronic timing device of the present invention.

FIG. 2 is a simplified block diagram illustrating one exemplary embodiment of the internal elements of an electronic timing device of the present invention.

### DETAILED DESCRIPTION OF PREFERRED EMBODIMENTS

The present invention comprises an electronic timing device that signals the passage of a single interval of time. The single interval of time is one sufficient to chill a beverage at or above room temperature in a standard household freezer to a preferred drinkable temperature. A preferred drinkable temperature is one in which the beverage is cold but has not reached a freezing temperature (i.e., about 32° F. or 0° C.). A preferred drinkable temperature includes temperatures in the range of 60° F. (16° C.) through 34° F. (1° C.), and more preferred includes temperatures in the range of 51° F. (11° C.) through 34° F. (1° C.).

Preferably, the single interval of time is an interval in the range of forty-five (45) to fifty-two (52) minutes. Most preferably, the interval of time is forty-five (45) minutes. As shown in Table 1 below, a forty-five (45) minute time interval is sufficient to chill a room temperature beverage to a preferred drinkable temperature.

TABLE 1

| | | | | Start | Time | End | End |
|---|---|---|---|---|---|---|---|
| | | | | Temp. | Interval | Temp. | Temp |
| Beverage | Container | Size/Vol. | | (° F.) | (min.) | (° F.) | (° C.) |
| Beer | Can | 12 | oz | 63.0 | 45 | 43.2 | 6.2 |
| Beer | Glass | 12 | oz | 63.0 | 45 | 40.8 | 4.9 |
| | bottle | | | | | | |
| Red Wine | Box | 5 | liters | 63.0 | 45 | 58.0 | 14.4 |
| Red Wine | Glass | 1.5 | liters | 63.0 | 45 | 47.3 | 8.5 |
| | bottle | | | | | | |
| Red Wine | Glass | .75 | | 63.0 | 45 | 49.0 | 9.4 |
| | bottle | | | | | | |
| Soda | Plastic | 2 | liters | 63.0 | 45 | 50.9 | 10.5 |
| | bottle | | | | | | |
| Soda | Can | 12 | oz | 63.0 | 45 | 37.4 | 3.0 |
| Soda | Glass | 12 | oz | 63.0 | 45 | 34.2 | 1.2 |
| | bottle | | | | | | |
| Water | Plastic | 1 | liter | 63.0 | 45 | 39.1 | 3.9 |
| | bottle | | | | | | |
| Water | Plastic | .5 | liters | 63.0 | 45 | 45.7 | 7.6 |
| | bottle | | | | | | |
| White | Box | 5 | liters | 63.0 | 45 | 58.3 | 14.6 |
| Wine | | | | | | | |
| White | Glass | 1.5 | liters | 63.0 | 45 | 48.2 | 9.0 |
| Wine | bottle | | | | | | |
| White | Glass | .75 | liters | 63.0 | 45 | 45.6 | 7.6 |
| Wine | bottle | | | | | | |

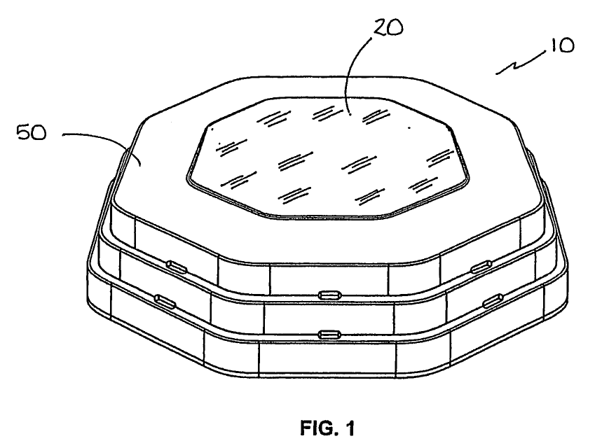

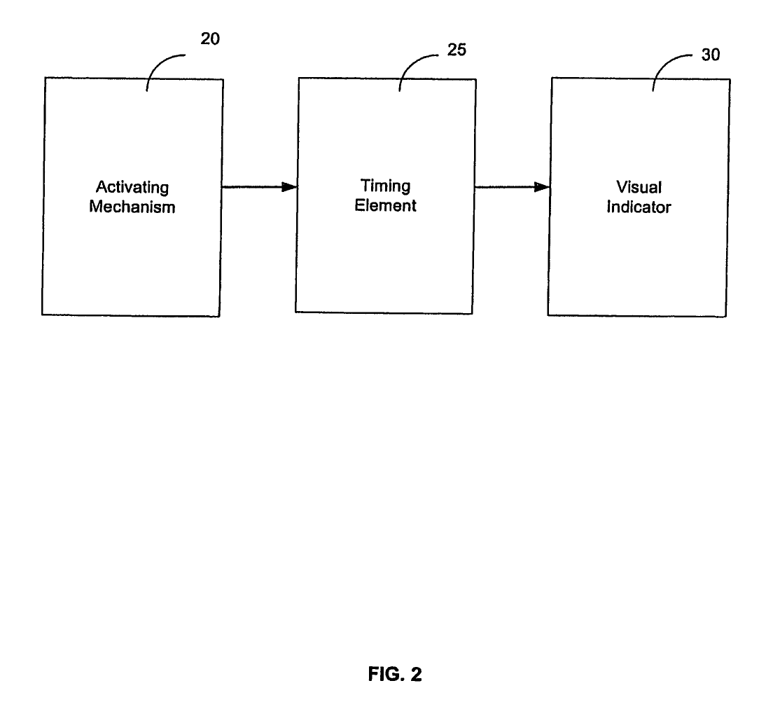

Turning now to the Figures, FIG. 1 is a simplified illustration of an exemplary embodiment of the external features of an electronic timing device 10 of the present invention. As illustrated in FIG. 2, the exemplary electronic timing device of the present invention comprises at least activating mechanism 20, timing element 25 that measures a single interval of time upon activation by the activating mechanism 20, and visual indicator 30 that is activated by timing element 25 upon the elapse of the single interval of time.

Activating mechanism 20 may be a button, a switch, an infra-red signal receiver, or a radio wave frequency receiver. Additionally, the placement and external features of activating mechanism 20 will depend upon the type of activating mechanism utilized in the embodiment of the present invention. For example, activating mechanism 20 of the exemplary embodiment shown in FIG. 1 is a centrally located button. Other variations in the type and location of activating mechanism 20 known or readily determinable to those of skill in the art may be alternatively used.

Timing element 25 may include any structure capable of consistently measuring a period of time. Many such structures are known to those of skill in the art. Such structures include, for example, but are not limited to, quartz crystals, electrical timing circuits, or microprocessors containing timing logic. Most importantly, timing element 25 can be set to only one time period. This single time period is either preset at the point of manufacture.

Visual indicator 30 is preferably an LED. However, other variations of visual indicators may be utilized in the electronic timing device of the present invention. Many such variations are known to those of skill in the art. Additionally, the placement of visual indicator 30 will depend upon the type of visual indicator 30 utilized as well as the aesthetic placement of visual indicator 30 within the electronic timing device. For example, the exemplary embodiment shown in FIG. 1 could utilize an LED that is visible through activating mechanism 20 when the LED is activated. Alternatively, an audio indicator may be used instead of or in combination with the visual indicator.

Activating mechanism 20, timing element 25, and visual indicator 30 are all contained within a single housing 50. Housing 50 may be formed from a number of materials, including but not limited to plastic, metal, or any combination of these materials. Many such materials are known to those of skill in the art. Preferably, the housing is made of anodized aluminum. The size and shape of an electronic timing device of the present invention is dependant upon aesthetics as well as the size of activating mechanism 20, timing element 25, and visual indicator 30 to be contained within housing 50. Preferably, the size of electronic timing device 10 is small enough to attach to the outside of a freezer door via an adhesive or magnetic material for convenience when using the device. Additionally, the size of electronic timing device 10 is small enough to allow it to be portable.

An exemplary operation of an electronic timing device of the present invention for rapidly chilling a beverage at or above room temperature would be as follows:

First, a person would place a beverage at or above room temperature into a freezer. Any type of beverage volume or beverage, and beverage packaging may be used with an electronic timing device of the present invention. However, the beverage volumes of two (2) liters or less are preferable. It is also preferable that the beverage is packaged within a glass, metal, or plastic container. Additionally, while an electronic timing device of the present invention may be used in a commercial environment, the electronic timing device of the invention is most advantageously used in the home setting within a standard household freezer.

After the beverage is placed within the freezer the person would activate electronic timing device 10 via activating mechanism 20 and place the electronic timing device in a convenient location to see and/or hear when the time has elapsed. Activating mechanism 20 would then initiate timing element 25 to count down the preset interval of time. Upon the lapse of the preset interval of time, timing element 25 would activate visual indicator 30 and/or an audible indicator (not shown).

Upon viewing visual indicator 30, the person would remove the beverage from the freezer for immediate consumption or long term storage in a refrigerator or cooler.

While exemplary embodiments have been described, persons of skill in the art will appreciate that variations may be made without departure from the scope and spirit of the invention. The true scope and spirit of the invention is defined by the following claims.

What is claimed:

1. An electronic timing device comprising:
an activating mechanism;
a timing element that measures a single interval of time upon activation by the activating mechanism; and
a visual indicator that is activated by the timing element upon the elapse of the single interval of time.

2. The electronic device of claim 1 wherein the single interval of time is an interval in the range of 45-52 minutes.

3. The electronic timing device of claim 1 wherein the single interval of time is 45 minutes.

4. The electronic timing device of claim 1 further comprising an audio indicator that is also activated by the timing element upon the elapse of the single interval of time.

5. The electronic timing device of claim 1 further comprising a magnetic backing.

6. A method for rapidly chilling a room temperature beverage comprising the steps of:
(a) placing a container of beverage into a freezer;
(b) activating an electronic timing device comprising an activating mechanism, a timing element that measures a single interval of time upon activation by the activating mechanism; and a visual indicator that is activated by the timing element upon the elapse of the single interval of time;
(c) activating the visual indicator upon elapse of the single interval of time; and
(d) removing the container of beverage from the freezer upon activation of the visual indicator of the electronic timing device.
